(19) United States
(12) Patent Application Publication
(10) Pub. No.: US 2015/0307670 A1
(43) Pub. Date: Oct. 29, 2015

(54) THIN LOW FRICTION LINERS

(71) Applicant: SAINT-GOBAIN PERFORMANCE PLASTICS CORPORATION, Aurora, OH (US)

(72) Inventors: Brian McNamara, Co. Clare (IE); Edward Cooke, Co. Clare (IE); Marta Miciula-Osak, Co. Clare (IE); Ian D. Hutcheson, Co. Clare (IE); Dale Thomas, Rochdale (GB); Joachim Reder, Koeln (DE); Ajay Padwal, Merrimack, NH (US)

(21) Appl. No.: 14/694,600

(22) Filed: Apr. 23, 2015

Related U.S. Application Data
(60) Provisional application No. 61/984,488, filed on Apr. 25, 2014.

(51) Int. Cl. C08J 5/04

(52) U.S. Cl. CPC C08J 5/04; C08J 2327/18

(57) ABSTRACT

The present disclosure is directed to composite structures, such as low friction liners, exhibiting superior performance. In certain embodiments of the present disclosure, a composite structure can include a first outer major surface adapted to contact a movable surface, and a second outer major surface adapted to contact a stationary surface, wherein the first outer major surface has a lower surface roughness than the second outer major surface, and wherein the composite has a mean average thickness of less than 0.3 mm. The composite structure can have unexpected synergistic improvement in properties such as low surface roughness, high dielectric strength, high resistance to edge wicking, high resistance to surface wicking, low content of surface defects, an increased abrasion resistance, and combinations thereof, particularly the maintenance of these properties over a long life.

### CROSS-REFERENCE TO RELATED APPLICATION(S)

This application claims priority under 35 U.S.C. §119(e) to U.S. Provisional Patent Application 61/984,488 entitled “THIN LOW FRICTION LINERS,” by McNamara et al., filed Apr. 25, 2014. Each patent application cited herein is hereby incorporated by reference in its entirety.

### FIELD OF THE DISCLOSURE

The present disclosure relates to composites having at least one side having a low surface roughness, and more particularly to, composites for placement between a movable surface and a stationary surface.

### RELATED ART

Composite structures, such as low friction liners, are often used in a bearing assembly, such as in an actuator or solenoid. The composite structures can provide a smooth sliding surface for the sliding of the movable surface in such an assembly.

State of the art liners have many drawbacks. For example, it has heretofore been unknown how to reduce the thickness of the composite structure to very thin levels while maintaining satisfactory performance, such as surface roughness, wear resistance, and the like.

Embodiments of the present disclosure solve these and other problems. For example, embodiments of the present disclosure provide novel composite structures exhibiting synergistic improvements in properties such as low surface roughness, high dielectric strength, high transparency to electromagnetic forces, high resistance to edge wicking, high resistance to surface wicking, low content of surface defects, an increased abrasion resistance, and combinations thereof while reducing the thickness of the entire composite. The synergism of combinations of such properties has never before been able to be achieved.

Moreover, embodiments of the present disclosure are also directed to novel assemblies incorporating the composite structure described herein. Without wishing to be bound by theory, the current inventors have surprisingly discovered that the composite structure described herein can enable synergistic performance of certain proprieties of a bearing assembly such as faster reaction times, lower power consumption, higher reactivity, compactness, lower wear rates, and greater fuel efficiency. The synergism of combinations of such properties has never before been able to be achieved.

### BRIEF DESCRIPTION OF THE DRAWINGS

Embodiments are illustrated by way of example and are not limited in the accompanying figures.

FIG. 1 includes an illustration of a composite structure according to one embodiment.

FIG. 2 includes an illustration of a composite structure according to another embodiment.

FIG. 3 includes an illustration of a reinforcement material according to one embodiment.

FIG. 4 includes a cross section illustration of a woven reinforcement material and a coating according to one embodiment.

Skilled artisans appreciate that elements in the figures are illustrated for simplicity and clarity and have not necessarily been drawn to scale. For example, the dimensions of some of the elements in the figures may be exaggerated relative to other elements to help to improve understanding of embodiments of the invention.

### DETAILED DESCRIPTION

The following description in combination with the figures is provided to assist in understanding the teachings disclosed herein. The following discussion will focus on specific implementations and embodiments of the teachings. This focus is provided to assist in describing the teachings and should not be interpreted as a limitation on the scope or applicability of the teachings. However, other embodiments can be used based on the teachings as disclosed in this application.

The terms “comprises,” “comprising,” “includes,” “including,” “has,” “having” or any other variation thereof, are intended to cover a non-exclusive inclusion. For example, a method, article, or apparatus that comprises a list of features is not necessarily limited only to those features but may include other features not expressly listed or inherent to such method, article, or apparatus. Further, unless expressly stated to the contrary, “or” refers to an inclusive- or and not to an exclusive- or. For example, a condition A or B is satisfied by any one of the following: A is true (or present) and B is false (or not present), A is false (or not present) and B is true (or present), and both A and B are true (or present).

Also, the use of “a” or “an” is employed to describe elements and components described herein. This is done merely for convenience and to give a general sense of the scope of the invention. This description should be read to include one, at least one, or the singular as also including the plural, or vice versa, unless it is clear that it is meant otherwise. For example, when a single item is described herein, more than one item may be used in place of a single item. Similarly, where more than one item is described herein, a single item may be substituted for that more than one item.

Unless otherwise defined, all technical and scientific terms used herein have the same meaning as commonly understood by one of ordinary skill in the art to which this invention belongs. The materials, methods, and examples are illustrative only and not intended to be limiting. To the extent not described herein, many details regarding specific materials and processing acts are conventional and may be found in textbooks and other sources within the composite fabric arts.

The present disclosure is directed to composite fabrics, having improved and even synergistic performance enhancements in properties such as various combinations of low surface roughness, high dielectric strength, high resistance to edge wicking, high resistance to surface wicking, low content of surface defects, and increased abrasion resistance. The concepts are better understood in view of the embodiments described below that illustrate and do not limit the scope of the present invention.

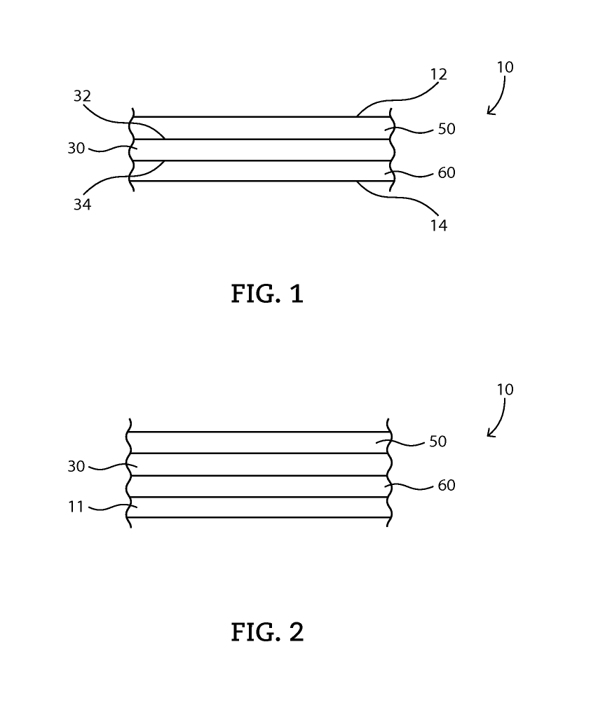

Referring now to FIG. 1, a composite structure 10 can include a reinforcement layer 30; a layer 50 comprising a fluoropolymer disposed adjacent a first outer surface 32 of the reinforcement layer 30; and a layer 60 comprising a fluoropolymer disposed adjacent a second outer surface 34 of the reinforcement layer 30.

The composite structure can further include a first outer surface 12 and a second outer surface 14. The first outer surface 12 and the second outer surface 14 can be adapted to form outer, exposed surfaces of a free standing composite structure 10. In certain embodiments, such as illustrated in FIG. 1, the outer surface of the layer 60 comprising a fluoropolymer, opposite the reinforcement layer, can be the first outer surface 12 of the composite structure. Further, in certain embodiments, such as illustrated in FIG. 1, the outer surface of the layer 50 comprising a fluoropolymer, opposite the reinforcement layer, can be the second outer surface 14 of the composite structure.

In certain embodiments, the first outer surface 12 can be adapted to contact a movable surface and the second outer surface 14 can be adapted to contact a stationary surface. In such embodiments, the composite can remain in a static, fixed position and the movable surface can slide or roll along the composite.

In certain embodiments, the composite structure 10 can further include any additional layers as known in the art. For example, as illustrated in FIG. 2, the composite structure 10 can further include an adhesive layer 11, forming the second outer surface 14 of the composite structure.

In certain embodiments, the reinforcement layer 30 can include a fabric. In particular embodiments, the fabric can be a woven fabric or a non-woven fabric. In very particular embodiments, the fabric can be a woven fabric.

In certain embodiments, the reinforcement layer 30 can have a generally low mean average thickness. A particular advantage of embodiments of the present disclosure is the achievement of the performance properties described herein at the particularly low mean average thicknesses of the reinforcement layer described herein. Accordingly, in certain embodiments, the reinforcement layer 30 can have a mean average of thickness of at least 0.01 mm, at least 0.02 mm, or even at least 0.03 mm. In further embodiments, the reinforcement layer 30 can have a mean average of thickness of no greater than 5 mm, no greater than 3 mm, no greater than 2 mm, no greater than 1 mm, no greater than 0.9 mm, no greater than 0.8 mm, no greater than 0.7 mm, no greater than 0.6 mm, no greater than 0.5 mm, no greater than 0.4 mm, no greater than 0.3 mm, or even no greater than 0.25 mm. Moreover, in certain embodiments, the reinforcement layer 30 can have a mean average thickness in a range of any of the minimum and maximum values provided above, such as in a range of 0.01 mm to 1 mm, 0.015 mm to 0.5 mm, or even 0.015 mm to 0.3 mm.

In certain embodiments, the reinforcement layer 30 can have a weight per unit area of at least 5 g/m², at least 10 g/m², at least 12 g/m², at least 14 g/m², at least 16 g/m², at least 18 g/m², at least 20 g/m², or even at least 25 g/m². In further embodiments, the reinforcement layer 30 can have a weight per unit area of no greater than 500 g/m², no greater than 400 g/m², no greater than 300 g/m², no greater than 275 g/m², no greater than 250 g/m², or even no greater than 200 g/m². Moreover, in certain embodiments, the reinforcement layer 30 can have a weight per unit area in a range of any of the minimum and maximum values provided above, such as in a range of 10 g/m² to 300 g/m², 15 g/m² to 275 g/m², or even 20 g/m² to 250 g/m².

In certain embodiments, the reinforcement layer 30 can include a plurality of fibers. In particular embodiments, the plurality of fibers can include glass fibers, polymeric fibers, aramid fibers, carbon fibers, or combinations thereof. In very particular embodiments, the plurality of fibers can include glass fibers.

In certain embodiments, the strands can include a coating layer around an individual strand. This coating layer can also be referred to as a sizing. In certain embodiments, the sizing on the strands can contain a polymer. In very particular embodiments, the sizing on the strands can contain a fluoropolymer, such as a perfluoropolymer, for example PTFE. In particular embodiments, the reinforcement layer can consist essentially of strands including a perfluoropolymer sizing.

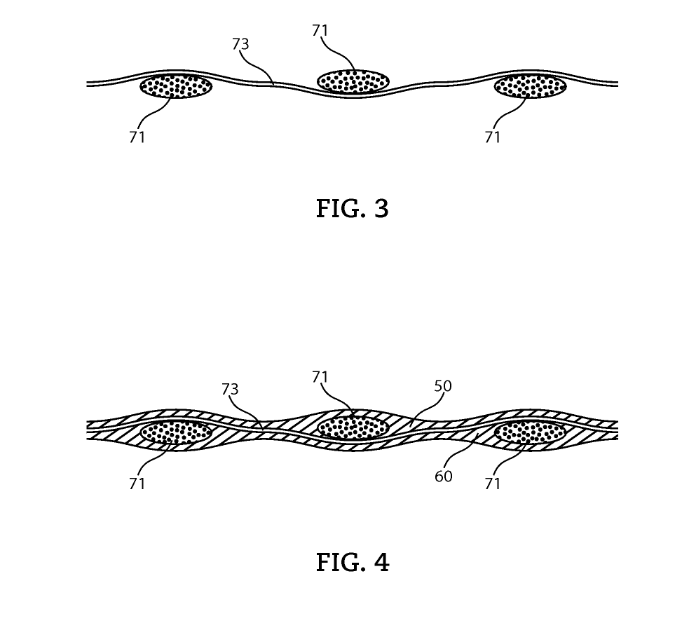

Referring now to FIG. 3, the strands can be formed into a plurality of yarns, and the yarns can be woven to form a fabric for a reinforcement layer. When woven, the yarns can include warp yarns 71 and fill yarns 73. As is understood in the art, warp yarns 71 and fill yarns 73 intersect and weave to form the woven fabric. The warp yarn 71 refers to the yarn in the machine direction during weaving, and the fill yarn 73 refers to the transverse machine direction during weaving. In certain embodiments, the warp yarns and/or the fill yarns can have a non-circular cross-section. For example, in very particular embodiments, the warp yarns and/or the fill yarns can be flat yarns. In particular embodiments, the warp yarns and/or the fill yarns can be twisted or untwisted. In very particular embodiments, the warp yarns and/or the fill yarns can be untwisted.

In certain embodiments, the plurality of warp yarns can have a mean average yarn width of at least 10 microns, at least 30 microns, at least 50 microns, at least 80 microns, at least 110 microns, at least 140 microns, at least 170 microns, at least 200 microns, at least 210 microns, at least 220 microns, at least 230 microns, at least 240 microns, at least 250 microns, at least 260 microns, or even at least 270 microns. In further embodiments, the plurality of warp yarns can have a mean average yarn width of no greater than 1000 microns, no greater than 800 microns, no greater than 700 microns, no greater than 600 microns, no greater than 500 microns, no greater than 450 microns, no greater than 400 microns, no greater than 350 microns, or even no greater than 300 microns. In still further embodiments, the plurality of warp yarns can have a mean average yarn width within a range of any of the minimum and maximum values provided above, such as in a range of 50 microns to 500 microns, 100 microns to 400 microns, or even 200 microns to 300 microns.

In certain embodiments, the plurality of warp yarns can have a mean average height of at least 1 microns, at least 5 microns, at least 10 microns, at least 15 microns, at least 20 microns, at least 25 microns, or even at least 30 microns. In further embodiments, the plurality of warp yarns can have a mean average height of no greater than 400 microns, no greater than 300 microns, no greater than 200 microns, no greater than 100 microns, no greater than 75 microns, no greater than 60 microns, or even no greater than 50 microns. In still further embodiments, the plurality of warp yarns can have a mean average height in a range of any of the minimum and maximum values provided above, such as in a range of 1 micron to 200 microns, 5 microns to 100 microns, or even 10 microns to 75 microns.

In certain embodiments, the plurality of warp yarns can have a mean average width which is greater than a mean average height. For example, in certain embodiments, the plurality of warp yarns can have a ratio of a mean average width to a mean average height of at least 1.5, at least 2, at least 2.5, at least 3, at least 3.5, at least 4, at least 4.5, at least 5, at least 5.5, at least 6, at least 6.5, or even at least 7. In certain further embodiments, the plurality of warp yarns can have a ratio of a mean average width to a mean average height of no greater than 100, no greater than 50, no greater than 25, no greater than 20, no greater than 15, no greater than 13, no greater than 11, or even no greater than 9. In still further embodiments, the plurality of warp yarns can have a ratio of a mean average width to a mean average height in a range of any of the minimum and maximums provided above, such as in a range of 2 to 20, 3 to 15, or even 5 to 13.

In certain embodiments, the plurality of fill yarns can have a mean average yarn width of at least 10 microns, at least 30 microns, at least 50 microns, at least 80 microns, at least 110 microns, at least 140 microns, at least 170 microns, at least 200 microns, at least 210 microns, at least 220 microns, at least 230 microns, at least 240 microns, at least 250 microns, at least 260 microns, at least 270 microns, at least 300 microns, at least 330 microns, or even at least 360 microns. In further embodiments, the plurality of fill yarns can have a mean average yarn width of no greater than 1000 microns, no greater than 800 microns, no greater than 700 microns, no greater than 600 microns, no greater than 500 microns, no greater than 450 microns, or even no greater than 400 microns. In still further embodiments, the plurality of fill yarns can have a mean average yarn width within a range of any of the minimum and maximum values provided above, such as in a range of 50 microns to 700 microns, 100 microns to 600 microns, or even 200 microns to 400 microns.

In certain embodiments, the plurality of fill yarns can have a mean average height of at least 1 microns, at least 5 microns, at least 10 microns, at least 15 microns, at least 20 microns, or even at least 25 microns. In further embodiments, the plurality of fill yarns can have a mean average height of no greater than 400 microns, no greater than 300 microns, no greater than 200 microns, no greater than 100 microns, no greater than 75 microns, no greater than 60 microns, or even no greater than 50 microns. In still further embodiments, the plurality of fill yarns can have a mean average height in a range of any of the minimum and maximum values provided above, such as in a range of 1 micron to 200 microns, 5 microns to 100 microns, or even 10 microns to 75 microns.

In certain embodiments, the plurality of fill yarns can have a mean average width which is greater than a mean average height. For example, in certain embodiments, the plurality of fill yarns can have a ratio of a mean average width to a mean average height of at least 1.5, at least 2, at least 2.5, at least 3, at least 3.5, at least 4, at least 4.5, at least 5, at least 5.5, at least 6, at least 6.5, at least 7, at least 8, at least 9, at least 10, at least 11, at least 12, at least 13, or even at least 14. In certain further embodiments, the plurality of fill yarns can have a ratio of a mean average width to a mean average height of no greater than 100, no greater than 50, no greater than 25, no greater than 23, no greater than 22, no greater than 21, no greater than 20, no greater than 19, no greater than 18, or even no greater than 17. In still further embodiments, the plurality of fill yarns can have a ratio of a mean average width to a mean average height in a range of any of the minimum and maximums provided above, such as in a range of 2 to 50, 5 to 25, or even 10 to 20.

In certain embodiments, the plurality of fill yarns have a greater ratio of the yarn width to yarn height than the warp yarns. For example, in certain embodiments, a ratio of the fill yarn width to height ratio to the warp yarn width to height ratio can be at least 1.1, at least 1.3, at least 1.5, at least 1.7, at least 1.9, or even at least 2. In further embodiments, a ratio of the fill yarn width to height ratio to the warp yarn width to height ratio can be no greater than 15, no greater than 10, no greater than 5, no greater than 4, or even no greater than 3. In still further embodiments, a ratio of the fill yarn width to height ratio to the warp yarn width to height ratio can be in a range of any of the minimum and maximum values provided above, such as in a range of 1.1 to 5, 1.3 to 4, or even 1.5 to 3.

In particular embodiments, and without wishing to be bound by theory, the novel construction of the composite described herein can enable a more unified and consistent composite structure. Traditional reinforcement materials, such as traditional woven reinforcement materials, have a large distance from peaks to valleys, and therefore a large surface roughness. When a further layer, such as a layer comprising a fluoropolymer as is described in more detail below, is formed onto the surface of the reinforcement material, a large amount of material was needed to completely fill the peaks and provide sufficient coverage over the valleys. Accordingly, such composite structures were limited in their ability to lower the thickness and retain desired performance. In contrast, the current inventors have surprisingly discovered a composite structure which synergistically lowers the thickness of the composite structure without the expected deterioration of performance.

Referring again to FIG. 1, the composite structure 10 can include a layer comprising a fluoropolymer 50, 60 disposed adjacent outer surfaces 32, 34 of the reinforcement layer 30.

For example, the reinforcement material 30 can be provided and a fluoropolymer containing composition can be applied to the reinforcement material to form the layer comprising a fluoropolymer 50, 60. In particular embodiments, the fluoropolymer can be coated onto the reinforcement material, such as by, for example, dip coating, spray coating, knife coating, or any other useful method. In other embodiments, the fluoropolymer containing composition can be formed as a separate sheet material and laminated onto the reinforcement material. Regardless of the method of forming the layer containing a fluoropolymer and applying to the reinforcement material, the fluoropolymer layer can cover the entire surface of the reinforcement material, such that essentially no part of at least one major surface (and preferably both major surfaces) of the reinforcement material is exposed as an outer major surface of the composite structure.

In certain embodiments, the layer comprising a fluoropolymer can include a fluorinated polymer or fluorinated copolymer such as polytetrafluoroethylene (PTFE), poly (tetrafluoroethylene-co-hexafluoropropylene (FEP), poly (tetrafluoroethylene-co-perfluoro (alkoxy vinyl ether)) (PFA), modified poly (ethylene-co-tetrafluoroethylene) (ETFE), poly (vinylidene fluoride) (PVDF), poly (chlorotrifluoroethylene) (PCTFE), MFA or combination thereof. In very particular embodiments, the layer comprising a fluoropolymer can include polytetrafluoroethylene (PTFE). In even further particular embodiments, the layer comprising a fluoropolymer can consist essentially of PTFE.

In certain embodiments, the layer comprising a fluoropolymer can further include any useful additives. In very particular embodiments, the layer comprising a fluoropolymer can further include an additive such as PEEK, PPS or combinations thereof.

In certain embodiments, the layer containing a fluoropolymer 50 and/or the layer containing a fluoropolymer 60, can have a mean average thickness of at least 0.005 mm, at least 0.01 mm, or even at least 0.02 mm. In further embodiments, the layer containing a fluoropolymer 50 and/or the layer containing a fluoropolymer 60, can have a mean average thickness of no greater than 1 mm, no greater than 0.5 mm, no greater than 0.4 mm, no greater than 0.35 mm, no greater than 0.3 mm, no greater than 0.25 mm, no greater than 0.2 mm, no greater than 0.15 mm, or even no greater than 0.1 mm. Moreover, in certain embodiments, the layer containing a fluoropolymer 50 and/or the layer containing a fluoropolymer 60, can have a mean average thickness in a range of any of the minimum and maximum values provided above, such as in a range of 0.01 mm to 0.5 mm, or even 0.02 mm to 0.1 mm. The mean average thickness of the fluoropolymer 50 or the fluoropolymer layer 60 can be measured by the calculating a mean average of the fluoropolymer layer thickness above the knuckles of the warp yarn and the fluoropolymer layer thickness above the fill yarn, between the knuckles of the warp yarn.

As discussed above, the layer containing a fluoropolymer 50 and/or the layer containing a fluoropolymer 60, can have a particularly low variability of the thickness of the fluoropolymer layer over the warp yarn knuckles. Further, the layer containing a fluoropolymer 50 and/or the layer containing a fluoropolymer 60, can have a particularly low variability of the thickness of the fluoropolymer layer over the fill yarn knuckles.

For example, in certain embodiments, the amount of variability between the thickness of the fluoropolymer layer over the warp yarn knuckles and/or the fill yarn knuckles can be no greater than +/−50 microns, no greater than +/−45 microns, no greater than +/−40 microns, no greater than +/−35 microns, no greater than +/−30 microns, no greater than +/−25 microns, no greater than +/−20 microns, no greater than +/−15 microns, no greater than +/−10 microns, no greater than +/−8 microns, no greater than +/−6 microns, or even no greater than +/−5 microns.

To measure the variability of the thickness of the fluoropolymer layer over the warp yarn knuckles, samples are embedded in epoxy overnight and then cross-section polished to a knuckle (fill crossovers a warp). The cross-section is imaged in a SEM. (Jeol 5600 LV SEM). Cross-sections are coated with Au/Pd before imaging. Image magnifications are 350× at ˜18 kV under backscattering mode, all of it done under vacuum. After imaging, the cross-section image is examined for coating thickness over the knuckle. Two sets of measurements are taken. The first is the thickness of the coating at the end of the yarn bundle, measured as the distance between farthest filament on either ends of the yarn bundle and the closer of the two edges of the sample along the thickness. A mean average of these two measurements is then calculated. The second measurement is the thickness of the coating at the thickest section of the yarn bundle, measured as the distance between the farthest filament at the thickest section of the yarn bundle and the closer of the two edges of the sample along the thickness. The variability of the thickness of the coating layer over the warp yarn knuckle is then calculated as the different between the mean average of the first set of measurements and the second measurement.

To measure the variability of thickness of the coating layer over the fill yarn knuckles, the same procedure is repeated as indicated above, except the cross section is sampled perpendicular to that of the warp yarn knuckles.

In certain embodiments, the layer containing a fluoropolymer 50 and/or the layer containing a fluoropolymer 60, can have a weight per unit area of at least 10 g/m², at least 20 g/m², at least 25 g/m², at least 25 g/m², at least 30 g/m², at least 35 g/m², or even at least 40 g/m². In further embodiments, the layer containing a fluoropolymer 50 and/or the layer containing a fluoropolymer 60, can have a weight per unit area of no greater than 600 g/m², no greater than 500 g/m², no greater than 450 g/m², no greater than 400 g/m², no greater than 350 g/m2, no greater than 300 g/m2, no greater than 250 g/m2, no greater than 200 g/m2, no greater than 170 g/m2, no greater than 160 g/m2, no greater than 150 g/m2, no greater than 140 g/m2, no greater than 130 g/m2, no greater than 120 g/m2, no greater than 110 g/m2, or even no greater than 105 g/m2. Moreover, in certain embodiments, the layer containing a fluoropolymer 50 and/or the layer containing a fluoropolymer 60, can have a weight per unit area in a range of any of the minimum and maximum values provided above, such as in a range of 25 g/m² to 500 g/m², 30 g/m2 to 170 g/m², or even 35 g/m2 to 150 g/m².

The composite structure can have an advantageous surface roughness. In particular, the layer containing a fluoropolymer 60, which can be adapted to be adjacent a movable surface, can form an outer surface of the composite structure, and can have an advantageous surface roughness. Furthermore, the layer containing a fluoropolymer 50, which can be adapted to be adjacent a stationary surface, can form a second outer surface of the composite structure, and can have an advantageous surface roughness. Surface roughness can be quantified and characterized by a number of different parameters as understood in the art including:

| | |
|---|---|
| Sa/Ra | Arithmetic mean deviation of the surface |
| Sq/Rq | Root-Mean-Square (RMS) deviation of the surface |
| St/Rt | Total height of the surface |
| Sp/Rp | Maximum height of summits |
| Sv/Rv | Maximum depth of valleys |
| Sz/Rz | Ten Point Height of the surface |

As used herein, the phrase “Mean Plane” refers to a straight line that is generated by calculating a weighted average for each data point resulting in equal areas above and below the line. The mean plane is also known as the center line.

The definitions and test methods for calculating each of these surface roughness parameters is included in ISO 4287 and EUR 15178 EN. These test methods and surface parameters are well understood in the art. Composite structures described herein can be measured for their surface roughness parameters using a Nanovea 3D Surface Profilometer, which uses a white light chromatic aberration technique. In these measurements, a scan area is defined as a 5.0 mm×5.0 mm section, and a step size of 10 microns is used for both the X axis and Y axis.

In certain embodiments, the composite structure can have a Sa of no greater than 80 microns, no greater than 70 microns, no greater than 60 microns, no greater than 55 microns, no greater than 50 microns, no greater than 48 microns, no greater than 46 microns, no greater than 35 microns, no greater than 30 microns, no greater than 20 microns, no greater than 15 microns, no greater than 10 microns, no greater than 9 microns, no greater than 8 microns, no greater than 7 microns, no greater than 6 microns, or even no greater than 5.5 microns, no greater than 5 microns, no greater than 4.5 microns, no greater than 4 microns, no greater than 3.5 microns, no greater than 3 microns, or even no greater than 2.5 microns. In further embodiments, the composite structure can have a Sa of at least 0.5 microns, at least 1 microns, or even at least 2 microns. In still further embodiments, the composite structure can have a Sa in a range of any of the minimum and maximums provided above, such as in a range of 0.5 microns to 10 microns, or even 1 micron to 8 microns.

In certain embodiments, the composite structure can have a Ra of no greater than 80 microns, no greater than 70 microns, no greater than 60 microns, no greater than 55 microns, no greater than 50 microns, no greater than 48 microns, no greater than 46 microns, no greater than 35 microns, no greater than 30 microns, no greater than 20 microns, no greater than 15 microns, no greater of no greater than 10 microns, no greater than 9 microns, no greater than 8 microns, no greater than 7 microns, no greater than 6 microns, no greater than 5.5 microns, no greater than 5 microns, no greater than 4.5 microns, no greater than 4 microns, no greater than 3.5 microns, no greater than 3 microns, or even no greater than 2.5 microns. In further embodiments, the composite structure can have a Ra of at least 0.5 microns, at least 1 microns, or even at least 2 microns. In still further embodiments, the composite structure can have a Ra in a range of any of the minimum and maximums provided above, such as in a range of 0.5 microns to 10 microns, or even 1 micron to 8 microns.

In certain embodiments, the composite structure can have a Sq of no greater than 80 microns, no greater than 70 microns, no greater than 60 microns, no greater than 55 microns, no greater than 50 microns, no greater than 48 microns, no greater than 46 microns, no greater than 35 microns, no greater than 30 microns, no greater than 20 microns, no greater than 15 microns, no greater than 15 microns, no greater than 14 microns, no greater than 13 microns, no greater than 12 microns, no greater than 11 microns, no greater than 10 microns, no greater than 9 microns, no greater than 8 microns, no greater than 7 microns, no greater than 6 microns, no greater than 5 microns, no greater than 4 microns, no greater than 3 microns, or even no greater than 2 microns. In further embodiments, the composite structure can have a Sq of at least 0.5 microns, at least 1 microns, or even at least 2 microns. In still further embodiments, the composite structure can have a Sq in a range of any of the minimum and maximums provided above, such as in a range of 0.5 microns to 10 microns, or even 1 micron to 8 microns.

In certain embodiments, the composite structure can have a Rq of no greater than 80 microns, no greater than 70 microns, no greater than 60 microns, no greater than 55 microns, no greater than 50 microns, no greater than 48 microns, no greater than 46 microns, no greater than 35 microns, no greater than 30 microns, no greater than 20 microns, no greater than 15 microns, no greater than 15 microns, no greater than 14 microns, no greater than 13 microns, no greater than 12 microns, no greater than 11 microns, no greater than 10 microns, no greater than 9 microns, no greater than 8 microns, no greater than 7 microns, no greater than 6 microns, no greater than 5 microns, no greater than 4 microns, no greater than 3 microns, or even no greater than 2 microns. In further embodiments, the composite structure can have a Rq of at least 0.5 microns, at least 1 microns, or even at least 2 microns. In still further embodiments, the composite structure can have a Rq in a range of any of the minimum and maximums provided above, such as in a range of 0.5 microns to 10 microns, or even 1 micron to 8 microns.

In certain embodiments, the composite structure can have a Sz of no greater than 80 microns, no greater than 70 microns, no greater than 60 microns, no greater than 55 microns, no greater than 50 microns, no greater than 48 microns, no greater than 46 microns, no greater than 35 microns, no greater than 30 microns, no greater than 20 microns, no greater than 15 microns, no greater than 10 microns, no greater than 9 microns, no greater than 8 microns, no greater than 7 microns, no greater than 6 microns, no greater than 5.5 microns, no greater than 5 microns, no greater than 4.5 microns, no greater than 4 microns, no greater than 3.5 microns, no greater than 3 microns, or even no greater than 2.5 microns. In further embodiments, the composite structure can have a Sz of at least 0.5 microns, at least 1 microns, or even at least 2 microns. In still further embodiments, the composite structure can have a Sz in a range of any of the minimum and maximums provided above, such as in a range of 0.5 microns to 10 microns, or even 1 micron to 8 microns.

In certain embodiments, the composite structure can have a Rz of no greater of no greater than 35 microns, no greater than 30 microns, no greater than 20 microns, no greater than 15 microns, no greater than 10 microns, no greater than 9 microns, no greater than 8 microns, no greater than 7 microns, no greater than 6 microns, no greater than 5.5 microns, no greater than 5 microns, no greater than 4.5 microns, no greater than 4 microns, no greater than 3.5 microns, no greater than 3 microns, or even no greater than 2.5 microns. In further embodiments, the composite structure can have a Rz of at least 0.5 microns, at least 1 microns, or even at least 2 microns. In still further embodiments, the composite structure can have a Rz in a range of any of the minimum and maximums provided above, such as in a range of 0.5 microns to 10 microns, or even 1 micron to 8 microns.

In certain embodiments, the composite structure can have a Sp of no greater than 35 microns, no greater than 30 microns, no greater than 20 microns, no greater than 15 microns, no greater than 10 microns, no greater than 9 microns, no greater than 8 microns, no greater than 7 microns, no greater than 6 microns, no greater than 5.5 microns, no greater than 5 microns, no greater than 4.5 microns, no greater than 4 microns, no greater than 3.5 microns, no greater than 3 microns, or even no greater than 2.5 microns. In further embodiments, the composite structure can have a Sp of at least 0.5 microns, at least 1 microns, or even at least 2 microns. In still further embodiments, the composite structure can have a Sp in a range of any of the minimum and maximums provided above, such as in a range of 0.5 microns to 10 microns, or even 1 micron to 8 microns.

In certain embodiments, the composite structure can have a Rp of no greater than 35 microns, no greater than 30 microns, no greater than 20 microns, no greater than 15 microns, no greater than 10 microns, no greater than 9 microns, no greater than 8 microns, no greater than 7 microns, no greater than 6 microns, no greater than 5.5 microns, no greater than 5 microns, no greater than 4.5 microns, no greater than 4 microns, no greater than 3.5 microns, no greater than 3 microns, or even no greater than 2.5 microns. In further embodiments, the composite structure can have a Rp of at least 0.5 microns, at least 1 microns, or even at least 2 microns. In still further embodiments, the composite structure can have a Rp in a range of any of the minimum and maximums provided above, such as in a range of 0.5 microns to 10 microns, or even 1 micron to 8 microns.

In certain embodiments, the composite structure can have a Sv of no greater than 35 microns, no greater than 30 microns, no greater than 20 microns, no greater than 15 microns, no greater than 10 microns, no greater than 9 microns, no greater than 8 microns, no greater than 7 microns, no greater than 6 microns, no greater than 5.5 microns, no greater than 5 microns, no greater than 4.5 microns, no greater than 4 microns, no greater than 3.5 microns, no greater than 3 microns, or even no greater than 2.5 microns. In further embodiments, the composite structure can have a Sv of at least 0.5 microns, at least 1 microns, or even at least 2 microns. In still further embodiments, the composite structure can have a Sv in a range of any of the minimum and maximums provided above, such as in a range of 0.5 microns to 10 microns, or even 1 micron to 8 microns.

In certain embodiments, the composite structure can have a Rv of no greater than 35 microns, no greater than 30 microns, no greater than 20 microns, no greater than 15 microns, no greater than 10 microns, no greater than 9 microns, no greater than 8 microns, no greater than 7 microns, no greater than 6 microns, no greater than 5.5 microns, no greater than 5 microns, no greater than 4.5 microns, no greater than 4 microns, no greater than 3.5 microns, no greater than 3 microns, or even no greater than 2.5 microns. In further embodiments, the composite structure can have a Rv of at least 0.5 microns, at least 1 microns, or even at least 2 microns. In still further embodiments, the composite structure can have a Rv in a range of any of the minimum and maximums provided above, such as in a range of 0.5 microns to 10 microns, or even 1 micron to 8 microns.

In certain embodiments, the composite structure can have a St of no greater than 80 microns, no greater than 70 microns, no greater than 60 microns, no greater than 55 microns, no greater than 50 microns, no greater than 48 microns, no greater than 46 microns, no greater than 35 microns, no greater than 30 microns, no greater than 20 microns, no greater than 15 microns, no greater than 10 microns, no greater than 9 microns, no greater than 8 microns, no greater than 7 microns, no greater than 6 microns, no greater than 5.5 microns, no greater than 5 microns, no greater than 4.5 microns, no greater than 4 microns, no greater than 3.5 microns, no greater than 3 microns, or even no greater than 2.5 microns. In further embodiments, the composite structure can have a St of at least 0.5 microns, at least 1 microns, or even at least 2 microns. In still further embodiments, the composite structure can have a St in a range of any of the minimum and maximums provided above, such as in a range of 0.5 microns to 10 microns, or even 1 micron to 8 microns.

In certain embodiments, the composite structure can have a Rt of no greater than 80 microns, no greater than 70 microns, no greater than 60 microns, no greater than 55 microns, no greater than 50 microns, no greater than 48 microns, no greater than 46 microns, no greater than 35 microns, no greater than 30 microns, no greater than 20 microns, no greater than 15 microns, no greater than 10 microns, no greater than 9 microns, no greater than 8 microns, no greater than 7 microns, no greater than 6 microns, no greater than 5.5 microns, no greater than 5 microns, no greater than 4.5 microns, no greater than 4 microns, no greater than 3.5 microns, no greater than 3 microns, or even no greater than 2.5 microns. In further embodiments, the composite structure can have a Rt of at least 0.5 microns, at least 1 microns, or even at least 2 microns. In still further embodiments, the composite structure can have a Rt in a range of any of the minimum and maximums provided above, such as in a range of 0.5 microns to 10 microns, or even 1 micron to 8 microns.

In certain embodiments, the layer containing a fluoropolymer 50, which can be adapted to be adjacent a stationary surface in an assembly can have essentially the same mean average thickness, standard deviation of mean average thickness, weight per unit area, surface roughness, or combinations thereof as the layer containing a fluoropolymer 60, which can be adapted to be adjacent a movable surface in an assembly. In other embodiments, the layer containing a fluoropolymer 60, which can be adapted to be adjacent a movable surface can have a greater or smaller: mean average thickness, standard deviation of mean average thickness, weight per unit area, surface roughness or combinations thereof than the layer containing a fluoropolymer 50, which can be adapted to be adjacent a stationary surface in a bearing assembly.

For example, in very particular embodiments, the layer containing a fluoropolymer 60 can have a lower mean average thickness than the layer containing a fluoropolymer 50. As another example, in certain embodiments, the layer containing a fluoropolymer 60 can have a greater standard deviation of mean average thickness than the layer containing a fluoropolymer 50. In other very particular embodiments, the layer containing a fluoropolymer 60 can have a lower standard deviation of mean average thickness than the layer containing a fluoropolymer 50. In very particular embodiments, the layer containing a fluoropolymer 60 can have a greater weight per unit area than the layer containing a fluoropolymer 50. In other very particular embodiments, the layer containing a fluoropolymer 60 can have a lower weight per unit area than the layer containing a fluoropolymer 50.

As still yet a further example, in certain embodiments, a ratio of the surface roughness of the layer containing a fluoropolymer 60 to the surface roughness of the layer containing a fluoropolymer 50 can be at least 1, at least 2, at least 2.5, or even at least 3. In further embodiments, a ratio of the surface roughness of the layer containing a fluoropolymer 60 to the surface roughness of the layer containing a fluoropolymer 50 can be no greater than 50, no greater than 40, no greater than 30, no greater than 20, or even no greater than 10. Moreover, in certain embodiments, a ratio of the surface roughness of the layer containing a fluoropolymer 60 to the surface roughness of the layer containing a fluoropolymer 50 can be in a range of any of the minimum and maximum values provided above, such as in a range of 1 to 50, or even 3 to 10. In very particular embodiments, the layer containing a fluoropolymer 60 can have a lower surface roughness than the layer containing a fluoropolymer 50. It is understood that the term “surface roughness” as used herein can refer to any of the surface roughness parameters described herein, such as Sa/Ra, Sq/Rq, Sz/Rz, Sp/Rp, Sv/Rv, or St/Rt, or any combination thereof.

In further embodiments, the second outer surface 14, which can be adapted to be adjacent a stationary surface, can contain different surface features or a different structure than the first outer surface 12. In particular, the second outer surface 14 can be tailored to increase the ability of the composite structure to hold in place against a stationary surface, such that the composite or liner is maintained in a stationary state when a movable surface is movably interacting with the first outer surface 12. For example, the second outer surface 14 can be etched or treated to improve the composites ability to maintain a stationary state when a movable surface is movably interacting with the first outer surface 12.

In very particular embodiments, the second outer surface 14 of the composite structure can have a desirable surface tension as measured according to. The Surface Tension Test. The Surface Tension Test measures the ability of the composite to hold its place against a surface. In certain embodiments, a composite or liner described herein can have one outer surface which can pass the Surface Tension Test with a wide range of test ink surface tensions.

To perform the Surface Tension Test, a sample (at least 100 mm x full width) is cut from the start of the production run and place it on a level surface. Alternatively, the test may be carried out directly on the roll without removing the sample. Ink is brushed along the full width of the fabric, re-dipping the ink if necessary more than once. If the ink wets the surface within two seconds without forming globules, the treatment level of the film is either higher than, or exactly that of the liquid. This is a good result. If the ink does form globules and does not show a “good” print adhesion to the etched fabric this is a failure. The surface tension of the ink can be varied to determine different performances.

In particular embodiments, a composite or liner described herein can have one outer surface which can pass the Surface Tension Test using an ink having a surface tension of 38 mN/m, 36 mN/m, 34, mN/m, 32 mN/m, 30 mN/m, 28 mN/m, 26 mN/m, 24 mN/m, 22 mN/m, or even 20 mN/m.

In certain embodiments, the composite structure 10 can have a mean average thickness of no greater than 10 mm, no greater than 1 mm, no greater than 0.5 mm, or even no greater than 0.3 mm. In further embodiments, the composite structure 10 can have a mean average thickness of at least 0.01 mm, at least 0.03 mm, at least 0.035, or even at least 0.05 mm. Moreover, in certain embodiments, the composite structure 10 can have a mean average thickness in a range of any of the minimum and maximum values described above, such as in a range of 0.01 mm to 10 mm, from 0.03 mm to 1 mm, or even from 0.05 mm to 0.5 mm.

In certain embodiments, the composite structure 10 can have a desired basis weight. For example, in certain embodiments, the composite structure 10 can have a weight per unit area of at least 10 g/m², at least 20 g/m², at least 30 g/m², at least 40 g/m², or even at least 50 g/m². In further embodiments, the composite structure 10 can have a weight per unit area of no greater than 1500 g/m², no greater than 1000 g/m², no greater than 800 g/m², no greater than 700 g/m², or even no greater than 650 g/m². Moreover, in certain embodiments, the composite structure 10 can have a weight per unit area in a range of any of the minimum and maximums provided above, such as in a range of 10 to 1000 g/m², or even 50 to 650 g/m².

It is to be understood that the composite structure can include any additional or further layers in addition to the layers described herein. Moreover, in very particular embodiments of the present disclosure, the composite structure, and bearing assemblies including the composite structure, can be devoid of an adhesive layer as a part of the composite structure or disposed between the composite structure and the stationary surface. For example, in particular embodiments, the second outer surface of the composite structure, which can be adapted to be adjacent a stationary surface, can be adapted to be disposed directly adjacent the stationary surface.

A particular advantage of certain embodiments of the present disclosure is the discovery that the surface roughness of the second major outer surface of the composite structure can differ from the surface roughness of the first major outer surface of the composite such that when the composite structure is incorporated as a bearing liner in a bearing assembly, the second major outer surface of the composite structure can be held directly against a stationary surface, and the composite structure remain static during bearing operation. Traditional composite structures for bearing liner application relied on an adhesive layer to hold the second major surface of the bearing liner statically to the stationary surface. Without such adhesive layer, failures could result when the composite structure moves, relative the stationary surface during operation of the bearing assembly. By devising embodiments of a composite structure that has a lower surface roughness than the first outer surface, it is possible to eliminate the need for an adhesive layer without the fear of the composite structure moving relative to the stationary surface.

As described herein, embodiments of the present disclosure are directed to novel composite structures exhibiting synergistic improvements in properties such as low surface roughness, high dielectric strength, high resistance to edge wicking, high resistance to surface wicking, low content of surface defects, an increased abrasion resistance, and combinations thereof. The synergism of combinations of such properties has never before been able to be achieved.

Moreover, as will be discussed in more detail elsewhere within this disclosure, embodiments of the present disclosure are also directed to novel bearing assemblies incorporating the composite structure described herein. Without wishing to be bound by theory, the current inventors have surprisingly discovered that the composite structure's described herein can enable synergistic performance of certain proprieties of a bearing assembly such as faster reaction times, lower power consumption, higher reactivity, compactness, and greater fuel efficiency, and the ability to maintain these desirable parameters over a long life. The synergism of combinations of such properties has never before been able to be achieved.

In certain embodiments, the composite structures described herein can have an advantageous outer surface roughness. The surface roughness can be an important characteristic of the composite structure, particularly in the context of a bearing liner in a bearing assembly. For example, in a bearing assembly, there is usually included a movable surface and a stationary surface, and the liner can be positioned between the movable surface and the stationary surface. The liner can be adapted to be static or fixed (relative to the stationary surface), and the movable surface slides or otherwise moves across the liner. Accordingly, it is desired to have one surface of the liner as smooth as possible to facilitate the sliding action and an opposite surface having a greater surface roughness to grip and hold against the stationary surface. Embodiments of the composite structure described herein can achieve desired advantageous surface roughness.

For example, as described in detail above, in certain embodiments the composite structure can contain a layer(s) comprising a fluoropolymer having the recited surface roughness. Further, as described above, the layer comprising a fluoropolymer 50 and/or the layer comprising a fluoropolymer 60 can form the outer surfaces of the composite structure. Accordingly, the composite structure can have a first outer surface and a second outer surface, opposite the first outer surface, which can have the corresponding surface roughness of the layer comprising a fluoropolymer 60 and a layer comprising a fluoropolymer 50 as recited above. It is to be understood that any further additional layers may be included adjacent the layer comprising a fluoropolymer, and in certain embodiments, the composite structure can still have the outer surface roughness and ratios of surface roughness described herein.

Another parameter useful to describe the composite structure's performance in assemblies where electrical shielding is desired is the composite structure's dielectric strength. Dielectric strength is a measure of the ability of a material to maintain its insulating properties when an electrical field is applied. At breakdown, the electric field frees bound electrons and if the applied electric field is sufficiently high, free electrons from background radiation may become accelerated to velocities that can liberate additional electrons during collisions with neutral atoms or molecules. Breakdown results in the formation of an electrically conductive path and a disruptive discharge through the material. A breakdown event can severely degrade, or even destroy, its insulating capability. The dielectric strength of a composite structure described herein is measured according to ASTM D149-81.

Embodiments of the composite structure described herein can have a desirable dielectric strength. In certain embodiments, the composite structure can have a dielectric strength of at least 0.5 kV, at least 1 kV, or even at least 1.5 kV. In further embodiments, the composite structure can have a dielectric strength of no greater than 20 kV, no greater than 15 kV, or even no greater than 10 kV. Moreover, in certain embodiments, the composite structure can have a dielectric strength in a range of any of the minimum and maximums provided above, such as in a range of 0.5 kV to 15 kV or even 1.5 kV to 10 kV.

Another parameter useful to describe the composite structure's performance in assemblies where liquid lubricants, such as grease or oil is present, is the composite structure's resistance to edge wicking. Resistance to edge wicking is a measure of the composite's ability to resist the penetration of unwanted materials through the edge of the composite's structure. A composite structure's ability to resist edge wicking can measured according to the Red Dye Test. Edge wicking is quantified as the distance the red dye travels from the edge toward the center of a composite structure sample. To perform the Red Dye Test, a specimen is immersed in a red dye solution for 5 minutes, and the level of penetration from the side of the specimen is measured. To prepare specimens for testing, 3 strips from the warp direction and 3 strips from the weft direction are cut at a width of 25 mm and a length of 170 mm Each strip is punched to create a hole in the top. To prepare the red dye solution, the following components are mixed: 0.5% Pylam Calco oil red z-1700; 29.85% Toulene; and 69.65% 2,2,4-trimethylepentane CAS (1540-84-1), wherein all percentages are by weight. The prepared strips are then placed in a tall glass jar containing the red dye solution and are held straight and separated by a stranded wire. After 5 minutes of immersion in the red dye solution, the specimens are placed under running water until the solution has been removed and then wiped dry. The ingress of the dye from both sides is then measured.

Embodiments of the composite structure described herein can have a desirable resistance to edge wicking, represented as a low edge wicking. In certain embodiments, the composite structure can have an edge wicking and penetration of no greater than 13 mm, no greater than 12 mm, no greater than 11 mm, no greater than 10 mm, no greater than 9 mm, no greater than 8 mm, no greater than 7 mm, or even no greater than 6 mm, no greater than 5 mm, no greater than 4 mm, no greater than 3 mm, or even no greater than 2 mm as measured according to the Red Dye Test. In further embodiments, the composite structure can have an edge wicking of at least 0.01 mm, or even at least 0.1 mm as measured according to the Red Dye Test. Moreover, in certain embodiments, the composite structure can have an edge wicking in a range of any of the minimum and maximum values described above, such as in a range of 0.01 to 10 mm, 0.1 mm to 9 mm, or even 0.1 mm to 8 mm as measured according to the Red Dye Test.

Another parameter useful to describe the composite structure's performance, particularly in assemblies where liquid lubricants, such as grease or oil are present, is the composite structure's resistance to surface wicking. The composition of the composite structure, it's method of manufacture, and particularly the presence of surface defects such as voids or pinholes on the outer surface of the composite structure can influence and affect the composite structure's resistance to surface wicking. In particular, voids or pinholes can allow a fluid to penetrate through the layer comprising a fluoropolymer and even into the reinforcement layer causing premature failure. Resistance to surface wicking rating is a qualitative measure of the composite structure's ability to resist the penetration of unwanted materials through the surface of the composite's structure. Resistance to surface wicking rating is measured according to the Fluorescent Dye Test. This test provides a measure of the surface coating quality of a coated fabric by means of ultra violet light lamp exposure of a dye-impregnated surface.

To perform the fluorescent dye test, specimens of the coated article of interest are brushed with a 50:50 Zyglo/water solution under a UV lamp. The lamp used herein is an ultra violet lamp, model UVGL-25 fitted to a UV test cabinet. The condition of the specimen is observed and compared with control samples. To begin, a specimen of a full width and 100 mm long is obtained. The specimen is brushed with 100 mL of the zyglo/water solution and left for 10 minutes under ambient conditions. Next, the specimen is placed under running water until the solution has been removed and then is wiped dry. The specimen is then placed into a UV cabinet with the long wave options enabled on the lamp. The specimen is examined and compared with a control specimen on the rating card. The rating card has a scale of 1 to 5, with 1 representing the best result. The procedure is then repeated on the opposite major surface. It is noted that the edges of the specimen will appear colored by leaching of dye due to capillary action. This appearance should be disregarded when comparing the appearance with the control specimens for the fluorescent dye test.

Embodiments of the composite structure described herein can have a desirable resistance to surface wicking rating as measured by the Fluorescent Dye Test. In certain embodiments, the composite structure can have a resistance to surface wicking rating of no greater than Level 2 or even no greater than Level 1 as measured by the Fluorescent Dye Test.

Another parameter useful to describe the composite structure's performance in bearing assemblies is the content of the composite structure's surface defects and thickness defects, particularly on an outer surface adapted to be adjacent a movable surface. As used herein, “surface defects” refers to surface defects including tower dust, dark particles, white spots, surfactant specs, sizing stains, burner dust, sheared coating material, such as PTFE, and weaving contamination, which are microscopically perceptible defects having a longest dimension of at least 0.1 mm. As used herein, “thickness defects” refers to clear bubbles or froth blisters which are microscopically perceptible thickness defects having a longest dimension of at least 0.1 mm. The content of surface defects and thickness defects of a composite structure described herein is measured according to The Surface and Thickness Defect Test. To perform the Surface and Thickness Defect Test, a sample of the composite structure is prepared by cutting a 297 mm×210 mm specimen across the width region of the sample. The 297 mm length is in the warp direction. Each specimen is visually observed by the naked eye for defects that could have a longest dimension of at least 0.1 mm. The observed defects are then microscopically observed under a power of 20× to 30× and categorized. Clear bubbles or froth blisters that are greater than 0.1 mm are labeled with a “B” and will be counted as a thickness defect. Any other visual defect, such as a dark particle, that has a longest dimension greater than 0.1 mm is labelled as “X.” Particles or defects less than 0.1 mm are labelled as “OK” and are not counted or considered defects within the Surface and Thickness Defect Test.

Embodiments of the composite structure described herein can have a desirable content of outer surface defects. In certain embodiments, a composite structure described herein can have no greater than 1000 outer surface defects per square meter, no greater than 900 outer surface defects per square meter, no greater than 800 outer surface defects per square meter, no greater than 700 outer surface defects per square meter, no greater than 600 outer surface defects per square meter, no greater than 500 outer surface defects per square meter, no greater than 400 outer surface defects per square meter, no greater than 300 outer surface defects per square meter, no greater than 200 outer surface defects per square meter, no greater than 100 outer surface defects per square meter, no greater than 75 outer surface defects per square meter, no greater than 50 outer surface defects per square meter, no greater than 40 outer surface defects per square meter, no greater than 30 outer surface defects per square meter, no greater than 20 outer surface defects per square meter, no greater than 15 outer surface defects per square meter, no greater than 10 outer surface defects per square meter, no greater than 8 outer surface defects per square meter, no greater than 7 outer surface defects per square meter, no greater than 6 outer surface defects per square meter, no greater than 5 outer surface defects per square meter, no greater than 4 outer surface defects per square meter, no greater than 3 outer surface defects per square meter, no greater than 2 outer surface defects per square meter, or even essentially free of outer surface defects.

Another parameter useful to describe the composite's performance is its trapezoidal tear strength. Trapezoidal tear strength is a well understood parameter in the art. The trapezoidal tear strength can be measured according to ASTM D5587.

Certain embodiments of a composite described herein can have a desirable trapezoidal tear strength as measured according to ASTM D5587. For example, in certain embodiments, the composite can have a trapezoidal tear strength of at least 1 N, at least 3 N, at least 5 N, at least 7 N, at least 9 N, at least 11 N, at least 13 N, at least 15 N, at least 17 N, at least 19 N, at least 21 N, or even at least 23 N. In further embodiments, the composite can have a trapezoidal tear strength of no greater than 200 N, no greater than 150 N, no greater than 100 N, no greater than 75 N, no greater than 50 N, or even no greater than 25 N. Moreover, in certain embodiments, the composite can have a trapezoidal tear strength in a range of any of the minimum and maximum values provided above, such as within a range of 5 N to 50 N, or even 11 N to 25 N.

Yet another parameter useful to describe the composite′ performance is its tensile strength. Tensile strength is a well understood parameter in the art. The tensile strength can be measured according to ASTM D902-95.

Certain embodiments of a composite described herein can have a desirable tensile strength as measured according to ASTM D902-95. For example, in certain embodiments, the composite can have a tensile strength of at least 20 N/cm, at least 30 N/cm, at least 40 N/cm, at least 50 N/cm, at least 60 N/cm, at least 70 N/cm, at least 80 N/cm, at least 90 N/cm, at least 100 N/cm, at least 110 N/cm, at least 120 N/cm, at least 130 N/cm, at least 140 N/cm, at least 150 N/cm, at least 160 N/cm, at least 170 N/cm, at least 180 N/cm, at least 190 N/cm, or even at least 200 N/cm. In further embodiments, the composite can have a tensile strength of no greater than 10000 N/cm, no greater than 5000 N/cm, no greater than 1000 N/cm, no greater than 500 N/cm, no greater than 300 N/cm, or even no greater than 250 N/cm. Moreover, the composite can have a tensile strength in a range of any of the minimum and maximums provided above, such as in a range of from 50 N/cm to 500 N/cm or even 100 N/cm to 250 N/cm.

As described herein, the composite structure described above can be particularly useful as a liner, such as in a bearing assembly including a stationary surface and a movable surface. For example, a bearing assembly, such as an actuator or solenoid in which there is shown a stationary surface, a movable surface, and a composite structure disposed between the stationary surface and the movable surface.

Without wishing to be bound by theory, with the composite structure described herein being arranged between a stationary surface and a movable surface, an increase in the reliability of the interaction between the components such as consistent performance over an expected lifetime, i.e. an increased number of cycles to failure can be obtained. Moreover, improved efficiencies in terms of lower power consumption and higher reactivity can be obtained. For example, the improved smoothness of the composite fabric can enable faster reaction times of an actuator or solenoid and therefore lower power consumption and increase reactivity. Moreover, the improved composite structure can enable smaller and lighter weight components in such an assembly. For example, in a solenoid, by use of a composite structure described herein, the solenoid coil size and weight can be reduced while still achieving equivalent performance. Additionally, the improved composite structure described herein can allow for an advantageous wear resistance, increasing the life and serviceability of the composite structure, and particular maintenance of the performance parameters discussed above over a longer life.

The present disclosure represents a departure from the state of the art. As described in detail herein, the current inventors surprisingly discovered a composite structure which can be used, for example, as a liner in a bearing assembly such as solenoids and actuators that has unparalleled performance in properties such as low surface roughness, high dielectric strength, high resistance to edge wicking, high resistance to surface wicking, low content of surface defects, an increased abrasion resistance, high wear resistance, and combinations thereof. The synergism of combinations of such properties has never before been able to be achieved with composite structures having the low thicknesses described herein. For example, particular embodiments are directed to very thin composites which also have improved surface roughness. Traditionally, as the composite size decreases to the levels described herein, the surface roughness increases. However, the novel composite structures described herein surprisingly achieved a maintenance of, and even an improvement in the surface roughness with thinner materials. As the composite thickness decreases, other performance parameters such as dielectric strength, resistance to edge wicking, resistance to surface wicking, content of surface defects, abrasion resistance, and wear resistance can deteriorate. However, the novel composite structures described herein synergistically improved these properties and combinations of these properties while decreasing thickness. Moreover, the described composite structure has enabled unparalleled synergistic performance in a bearing assembly in devices such as actuators and solenoids. For example, with the composite structure described herein being arranged between a stationary surface and a movable surface, an increase in the reliability of the interaction between the components such as consistent performance over an expected lifetime, i.e. an increased number of cycles to failure can be obtained. Furthermore, improved efficiencies in terms of lower power consumption and higher reactivity were unexpectedly realized. For example, the improved smoothness of the composite fabric can enable faster reaction times of an actuator or solenoid and therefore lower power consumption and increase reactivity, and these features can be maintained over more cycles.

Many different aspects and embodiments are possible. Some of those aspects and embodiments are described below. After reading this specification, skilled artisans will appreciate that those aspects and embodiments are only illustrative and do not limit the scope of the present invention. Embodiments may be in accordance with any one or more of the items as listed below.

Item 1. A composite comprising:
a. a first outer major surface and
b. a second outer major surface, opposite the first outer major surface,
c. wherein the first outer major surface is adapted to contact a movable surface, and
d. wherein the first outer major surface has a lower surface roughness than the second outer major surface; and
e. wherein the composite has a mean average thickness of less than 0.3 mm.

Item 2. A composite or liner comprising:
a. a first outer major surface and
b. a second outer major surface, opposite the first outer major surface,
c. wherein the first outer major surface is adapted to contact a movable surface,
d. wherein the second outer major surface is adapted to hold against a stationary surface in an assembly; and
e. wherein the second outer major surface is adapted to pass the Surface Tension Test using a reference ink having a surface tension of 38 mN/m.

Item 3. A liner comprising a composite structure comprising:
a. a reinforcement layer; and
b. a layer comprising a fluoropolymer disposed on the reinforcement layer;
c. wherein the composite structure has a mean average thickness of less than 0.3 mm, and
   i. wherein the reinforcement layer has a mean average weight of no greater than 210 g/m²; and/or
   ii. wherein the layer comprising a fluoropolymer has a mean average weight of no greater than 500 g/m².

Item 4. A liner comprising a composite structure comprising:
a. a woven fabric reinforcement layer; and
b. a layer comprising a fluoropolymer disposed on the woven fabric reinforcement layer;
c. wherein the liner has one or more of the following characteristics:
   i. a first outer surface having a surface roughness (Sa or Pa) of no greater than 46 microns;
   ii. a dielectric strength of greater than 1.5 kv as measured according to ASTM D149-81;
   iii. an edge wicking and penetration of no greater than 8 mm as measured according to the Red Dye Test;
   iv. a surface wicking and penetration of no worse than Level 2 as measured according to the Fluorescent Dye Test;
   v. a content of surface defects of no greater than 40 outer surface defects per square meter, wherein surface defects consist of tower dust, dark particles, white spots, surfactant specs, sizing stains, burner dust, sheared coating material, such as PTFE, and weaving contaminations having a longest dimension of 0.1 mm as measured according to microscopic inspection under the Surface and Thickness Defect Test; or
   vi. any combination thereof.

Item 5. A liner having a first outer major surface and a second outer major surface, wherein the first outer major surface is adapted to contact a movable surface, and wherein the second outer major surface may be adapted to contact a stationary surface, and wherein the first outer surface has a surface roughness of no greater than 5 Ra; and wherein the second outer surface has a surface roughness greater than the surface roughness of the first outer surface.

Item 6. A composite having a woven fabric reinforcement layer and a layer comprising a fluoropolymer disposed on the woven fabric reinforcement layer; wherein the layer comprising a fluoropolymer has a basis weight of less than 500 g/m²; and wherein an outer surface of the layer comprising the fluoropolymer has a surface roughness (Sa or Pa) of no greater than 46 microns.

Item 7. The composite or liner according to any one of the preceding items, wherein the second outer major surface is adapted to directly contact a stationary surface.

Item 8. The composite or liner according to any one of the preceding items, wherein the second outer major surface is adapted to directly contact a stationary surface without an adhesive layer disposed between the second outer major surface and the stationary surface.

Item 9. The composite or liner according to any one of the preceding items, wherein the composite structure consists essentially of the reinforcement material and the layer comprising a fluoropolymer.

Item 10. The composite or liner of any one of the preceding items, wherein the reinforcement layer comprises a fabric.

Item 11. The composite or liner of any one of the preceding items, wherein the reinforcement layer comprises a woven fabric.

Item 12. The composite or liner of any one of the preceding items, wherein the reinforcement layer has a mean average thickness of at least 0.01 mm, at least 0.02 mm, or even at least 0.03 mm.

Item 13. The composite or liner of any one of the preceding items, wherein the reinforcement layer has a mean average thickness of no greater than 5 mm, no greater than 3 mm, no greater than 2 mm, no greater than 1 mm, no greater than 0.9 mm, no greater than 0.8 mm, no greater than 0.7 mm, no greater than 0.6 mm, no greater than 0.5 mm, no greater than 0.4 mm, no greater than 0.3 mm, or even no greater than 0.25 mm.

Item 14. The composite or liner of any one of the preceding items, wherein the reinforcement layer has a mean average thickness in a range of 0.01 mm to 1 mm, 0.015 mm to 0.5 mm, or even 0.015 mm to 0.3 mm.

Item 15. The composite or liner of any one of the preceding items, wherein the reinforcement layer has a weight per unit area of at least 5 g/m², at least 10 g/m², at least 12 g/m², at least 14 g/m², at least 16 g/m², at least 18 g/m², at least 20 g/m², or even at least 25 g/m².

Item 16. The composite or liner of any one of the preceding items, wherein the reinforcement layer has a weight per unit area of no greater than 500 g/m², no greater than 400 g/m², no greater than 300 g/m², no greater than 275 g/m², no greater than 250 g/m², or even no greater than 200 g/m².

Item 17. The composite or liner of any one of the preceding items, wherein the reinforcement layer has a weight per unit area in a range of 10 g/m² to 300 g/m², 15 g/m² to 275 g/m², or even 20 g/m² to 250 g/m².

Item 18. The composite or liner of any one of the preceding items, wherein the reinforcement layer comprises a plurality of fibers, and wherein the plurality of fibers comprise glass, aramid, carbon, or any combination thereof.

Item 19. The composite or liner of any one of the preceding items, wherein the reinforcement layer comprises a plurality of fibers, and wherein the plurality of fibers comprise glass.

Item 20. The composite or liner of any one of the preceding items, wherein the reinforcement layer comprises a woven fabric, and wherein the woven fabric comprises a plurality of yarns.

Item 21. The composite or liner of any one of the preceding items, wherein the reinforcement layer comprises a plurality of strands formed from a plurality of fibers, and wherein at least one of the plurality of strands comprises an individual sizing.

Item 22. The composite or liner of any one of the preceding items, wherein the reinforcement layer comprises a plurality of strands formed from a plurality of fibers, and wherein at least one of the plurality of strands comprises an individual sizing comprising a perfluoropolymer.

Item 23. The composite or liner of any one of the preceding items, wherein the reinforcement layer comprises a woven fabric, and wherein the woven fabric comprises a plurality of warp yarns and fill yarns, and wherein the plurality of warp yarns have:
a. a mean average yarn width of at least at least 10 microns, at least 30 microns, at least 50 microns, at least 80 microns, at least 110 microns, at least 140 microns, at least 170 microns, at least 200 microns, at least 210 microns, at least 220 microns, at least 230 microns, at least 240 microns, at least 250 microns, at least 260 microns, or even at least 270 microns;
b. a mean average yarn width of no greater than 1000 microns, no greater than 800 microns, no greater than 700 microns, no greater than 600 microns, no greater than 500 microns, no greater than 450 microns, no greater than 400 microns, no greater than 350 microns, or even no greater than 300 microns; and/or
c. a mean average yarn width within a range of 50 microns to 500 microns, 100 microns to 400 microns, or even 200 microns to 300 microns.

Item 24. The composite or liner of any one of the preceding items, wherein the woven fabric reinforcement layer comprises a plurality of warp yarns and a plurality of fill yarns, and wherein the plurality of warp yarns have:
a. a mean average height of at least 1 microns, at least 5 microns, at least 10 microns, at least 15 microns, at least 20 microns, at least 25 microns, or even at least 30 microns;
b. a mean average height of no greater than 400 microns, no greater than 300 microns, no greater than 200 microns, no greater than 100 microns, no greater than 75 microns, no greater than 60 microns, or even no greater than 50 microns; and/or
c. a mean average height in a range of 1 micron to 200 microns, 5 microns to 100 microns, or even 10 microns to 75 microns.

Item 25. The composite or liner of any one of the preceding items, wherein the woven fabric reinforcement layer comprises a plurality of warp yarns and fill yarns, and wherein the plurality of warp yarns have a mean average width which is greater than a mean average height.

Item 26. The composite or liner of any one of the preceding items, wherein the woven fabric reinforcement layer comprises a plurality of warp yarns and fill yarns, and wherein the plurality of warp yarns have:
a. a ratio of a mean average width to a mean average height of at least 1.5, at least 2, at least 2.5, at least 3, at least 3.5, at least 4, at least 4.5, at least 5, at least 5.5, at least 6, at least 6.5, or even at least 7;
b. a ratio of a mean average width to a mean average height of no greater than 100, no greater than 50, no greater than 25, no greater than 20, no greater than 15, no greater than 13, no greater than 11, or even no greater than 9; and/or
c. a ratio of a mean average width to a mean average height in a range of 2 to 20, 3 to 15, or even 5 to 13.

Item 27. The composite or liner of any one of the preceding items, wherein the reinforcement layer comprises a woven fabric, and wherein the woven fabric comprises a plurality of warp yarns and fill yarns, and wherein the plurality of fill yarns have:
a. a mean average yarn width of at least 10 microns, at least 30 microns, at least 50 microns, at least 80 microns, at least 110 microns, at least 140 microns, at least 170 microns, at least 200 microns, at least 210 microns, at least 220 microns, at least 230 microns, at least 240 microns, at least 250 microns, at least 260 microns, at least 270 microns, at least 300 microns, at least 330 microns, or even at least 360 microns;
b. a mean average yarn width of no greater than 1000 microns, no greater than 800 microns, no greater than 700 microns, no greater than 600 microns, no greater than 500 microns, no greater than 450 microns, or even no greater than 400 microns; and/or
c. a mean average yarn width within a range of 50 microns to 700 microns, 100 microns to 600 microns, or even 200 microns to 400 microns.

Item 28. The composite or liner of any one of the preceding items, wherein the reinforcement layer comprises a woven fabric, and wherein the woven fabric comprises a plurality of warp yarns and fill yarns, and wherein the plurality of warp yarns have:
a. a mean average yarn height of at least 1 micron, at least 5 microns, at least 10 microns, at least 15 microns, at least 20 microns, or even at least 25 microns;
b. a mean average height of no greater than 400 microns, no greater than 300 microns, no greater than 200 microns, no greater than 100 microns, no greater than 75 microns, no greater than 60 microns, or even no greater than 50 microns; and/or
c. a mean average height in a range of 1 micron to 200 microns, 5 microns to 100 microns, or even 10 microns to 75 microns.

Item 29. The composite or liner of any one of the preceding items, wherein the reinforcement layer comprises a woven fabric, and wherein the woven fabric comprises a plurality of warp yarns and fill yarns, and wherein the plurality of fill yarns have:
a. a ratio of a mean average width to a mean average height of at least 1.5, at least 2, at least 2.5, at least 3, at least 3.5, at least 4, at least 4.5, at least 5, at least 5.5, at least 6, at least 6.5, at least 7, at least 8, at least 9, at least 10, at least 11, at least 12, at least 13, or even at least 14;
b. a ratio of a mean average width to a mean average height of no greater than 100, no greater than 50, no greater than 25, no greater than 23, no greater than 22, no greater than 21, no greater than 20, no greater than 19, no greater than 18, or even no greater than 17; and/or
c. a ratio of a mean average width to a mean average height in a range of 2 to 50, 5 to 25, or even 10 to 20.

Item 30. The composite or liner of any one of the preceding items, wherein the reinforcement layer comprises a woven fabric, and wherein the woven fabric comprises a plurality of warp yarns and fill yarns, and wherein the plurality of fill yarns have a greater ratio of the yarn width to yarn height than the warp yarns.

Item 31. The composite or liner of any one of the preceding items, wherein the reinforcement layer comprises a woven fabric, and wherein the woven fabric comprises a plurality of warp yarns and fill yarns, and wherein a ratio of the fill yarn width to height ratio to the warp yarn width to height ratio is:
a. at least 1.1, at least 1.3, at least 1.5, at least 1.7, at least 1.9, or even at least 2;
b. no greater than 15, no greater than 10, no greater than 5, no greater than 4, or even no greater than 3; and/or
c. in a range of 1.1 to 5, 1.3 to 4, or even 1.5 to 3.

Item 32. The composite or liner of any one of the preceding items, wherein the layer comprising a fluoropolymer is coated onto the reinforcement layer.

Item 33. The composite or liner of any one of the preceding items, wherein the layer comprising a fluoropolymer is laminated on the reinforcement layer.

Item 34. The composite or liner of any one of the preceding items, wherein the layer comprising a fluoropolymer is laminated on a partially fluoropolymer coated reinforcement layer.

Item 35. The composite or liner of any one of the preceding items, wherein the layer comprising a fluoropolymer comprises a perfluoropolymer.

Item 36. The composite or liner of any one of the preceding items, wherein the layer comprising a fluoropolymer comprises a fluorinated polymer or fluorinated copolymer comprising polytetrafluoroethylene (PTFE), poly (tetrafluoroethylene-co-hexafluoropropylene (FEP), poly (tetrafluoroethylene-co-perfluoro (alkoxy vinyl ether)) (PFA), modified poly (ethylene-co-tetrafluoroethylene) (ETFE), poly (vinylidene fluoride) (PVDF), poly (chlorotrifluoroethylene) (PCTFE), MFA; or combination thereof.

Item 37. The composite or liner of any one of the preceding items, wherein the fluoropolymer comprises PTFE.

Item 38. The composite or liner of any one of the preceding items, wherein the layer comprising a fluoropolymer has a mean average thickness of at least 0.005 mm, at least 0.01 mm, or even at least 0.02 mm.

Item 39. The composite or liner of any one of the preceding items, wherein the layer comprising a fluoropolymer has a mean average thickness of no greater than 1 mm, no greater than 0.5 mm, no greater than 0.3 mm, no greater than 0.2 mm, or even no greater than 0.1 mm.

Item 40. The composite or liner of any one of the preceding items, wherein the layer comprising a fluoropolymer has a mean average thickness in a range of 0.01 mm to 0.5 mm, or even 0.02 mm to 0.1 mm.

Item 41. The composite or liner of any one of the preceding items, wherein the layer comprising a fluoropolymer has a variability of thickness over the warp yarn knuckles of no greater than +/−50 microns, no greater than +/−45 microns, no greater than +/−40 microns, no greater than +/−35 microns, no greater than +/−30 microns, no greater than +/−25 microns, no greater than +/−20 microns, no greater than +/−15 microns, no greater than +/−10 microns, no greater than +/−8 microns, no greater than +/−6 microns, or even no greater than +/−5 microns.

Item 42. The composite or liner of any one of the preceding items, wherein the layer comprising a fluoropolymer has a variability of thickness over the fill yarn knuckles of no greater than +/−50 microns, no greater than +/−45 microns, no greater than +/−40 microns, no greater than +/−35 microns, no greater than +/−30 microns, no greater than +/−25 microns, no greater than +/−20 microns, no greater than +/−15 microns, no greater than +/−10 microns, no greater than +/−8 microns, no greater than +/−6 microns, or even no greater than +/−5 microns.

Item 43. The composite or liner of any one of the preceding items, wherein the layer comprising a fluoropolymer has a weight per unit area of at least 10 g/m², at least 20 g/m², at least 25 g/m², at least 25 g/m², at least 30 g/m², at least 35 g/m², or even at least 40 g/m².

Item 44. The composite or liner of any one of the preceding items, wherein the layer comprising a fluoropolymer has a weight per unit area of no greater than 600 g/m², no greater than 500 g/m², no greater than 450 g/m², no greater than 400 g/m², no greater than 350 g/m2, no greater than 300 g/m2, no greater than 250 g/m2, no greater than 200 g/m2, no greater than 170 g/m2, no greater than 160 g/m2, no greater than 150 g/m2, no greater than 140 g/m2, no greater than 130 g/m2, no greater than 120 g/m2, no greater than 110 g/m2, or even no greater than 105 g/m2.

Item 45. The composite or liner of any one of the preceding items, wherein the layer comprising a fluoropolymer has a weight per unit area in a range of 25 g/m² to 500 g/m², 30 g/m2 to 170 g/m², or even 35 g/m2 to 150 g/m².

Item 46. The composite or liner of any one of the preceding items, wherein the liner has a mean average thickness of no greater than 10 mm, no greater than 1 mm, no greater than 0.5 mm, or even no greater than 0.3 mm.

Item 47. The composite or liner of any one of the preceding items, wherein the liner has a mean average thickness of at least 0.01 mm, at least 0.03 mm, at least 0.035, or even at least 0.05 mm.

Item 48. The composite or liner of any one of the preceding items, wherein the liner has a mean average thickness in a range of 0.01 mm to 10 mm, from 0.03 mm to 1 mm, or even from 0.05 mm to 0.5 mm.

Item 49. The composite or liner of any one of the preceding items, wherein the liner has a first outer surface adapted to contact a movable surface, and wherein the liner has a second outer surface, opposite the first major outer surface, adapted to contact a stationary surface.

Item 50. The composite or liner of any one of the preceding items, wherein the liner has a first outer surface adapted to contact a movable surface, and wherein the liner has a second outer surface, opposite the first major outer surface, adapted to contact a stationary surface, and wherein the second outer surface is adapted to a contact a stationary surface without a layer of adhesive disposed between the second outer surface and the stationary surface.

Item 51. The composite or liner of any one of the preceding items, wherein the liner has a weight per unit area of at least 10 g/m², at least 20 g/m², at least 30 g/m², at least 40 g/m², or even at least 50 g/m².

Item 52. The composite or liner of any one of the preceding items, wherein the liner has a weight per unit area of no greater than 1500 g/m², no greater than 1000 g/m², no greater than 800 g/m², no greater than 700 g/m², or even no greater than 650 g/m².

Item 53. The composite or liner of any one of the preceding items, wherein the liner has a weight per unit area in a range of 10 to 1000 g/m², or even 50 to 650 g/m².

Item 54. The composite or liner of any one of the preceding items, wherein the composite structure has an outer surface having a surface roughness (Sa or Ra) of: no greater than 80 microns, no greater than 70 microns, no greater than 60 microns, no greater than 55 microns, no greater than 50 microns, no greater than 48 microns, no greater than 46 microns, no greater than 35 microns, no greater than 30 microns, no greater than 20 microns, no greater than 15 microns, no greater than 10 microns, no greater than 9 microns, no greater than 8 microns, no greater than 7 microns, no greater than 6 microns, or even no greater than 5.5 microns, no greater than 5 microns, no greater than 4.5 microns, no greater than 4 microns, no greater than 3.5 microns, no greater than 3 microns, or even no greater than 2.5 microns.

Item 55. The composite or liner of any one of the preceding items, wherein the composite structure has an outer surface having a surface roughness (Sq or Rq) of no greater than 80 microns, no greater than 70 microns, no greater than 60 microns, no greater than 55 microns, no greater than 50 microns, no greater than 48 microns, no greater than 46 microns, no greater than 35 microns, no greater than 30 microns, no greater than 20 microns, no greater than 15 microns, no greater than 15 microns, no greater than 14 microns, no greater than 13 microns, no greater than 12 microns, no greater than 11 microns, no greater than 10 microns, no greater than 9 microns, no greater than 8 microns, no greater than 7 microns, no greater than 6 microns, no greater than 5 microns, no greater than 4 microns, no greater than 3 microns, or even no greater than 2 microns.

Item 56. The composite or liner of any one of the preceding items, wherein the composite structure has an outer surface having a surface roughness (Sz or Rz) of no greater than 80 microns, no greater than 70 microns, no greater than 60 microns, no greater than 55 microns, no greater than 50 microns, no greater than 48 microns, no greater than 46 microns, no greater than 35 microns, no greater than 30 microns, no greater than 20 microns, no greater than 15 microns, no greater than 10 microns, no greater than 9 microns, no greater than 8 microns, no greater than 7 microns, no greater than 6 microns, no greater than 5.5 microns, no greater than 5 microns, no greater than 4.5 microns, no greater than 4 microns, no greater than 3.5 microns, no greater than 3 microns, or even no greater than 2.5 microns.

Item 57. The composite or liner of any one of the preceding items, wherein the composite structure has an outer surface having a surface roughness (Sp or Rp) of no greater than 35 microns, no greater than 30 microns, no greater than 20 microns, no greater than 15 microns, no greater than 10 microns, no greater than 9 microns, no greater than 8 microns, no greater than 7 microns, no greater than 6 microns, no greater than 5.5 microns, no greater than 5 microns, no greater than 4.5 microns, no greater than 4 microns, no greater than 3.5 microns, no greater than 3 microns, or even no greater than 2.5 microns.

Item 58. The composite or liner of any one of the preceding items, wherein the composite structure has an outer surface having a surface roughness (Sv or Rv) of no greater than 35 microns, no greater than 30 microns, no greater than 20 microns, no greater than 15 microns, no greater than 10 microns, no greater than 9 microns, no greater than 8 microns, no greater than 7 microns, no greater than 6 microns, no greater than 5.5 microns, no greater than 5 microns, no greater than 4.5 microns, no greater than 4 microns, no greater than 3.5 microns, no greater than 3 microns, or even no greater than 2.5 microns.

Item 59. The composite or liner of any one of the preceding items, wherein the composite structure has an outer surface having a surface roughness (St or Rt) of no greater than 80 microns, no greater than 70 microns, no greater than 60 microns, no greater than 55 microns, no greater than 50 microns, no greater than 48 microns, no greater than 46 microns, no greater than 35 microns, no greater than 30 microns, no greater than 20 microns, no greater than 15 microns, no greater than 10 microns, no greater than 9 microns, no greater than 8 microns, no greater than 7 microns, no greater than 6 microns, no greater than 5.5 microns, no greater than 5 microns, no greater than 4.5 microns, no greater than 4 microns, no greater than 3.5 microns, no greater than 3 microns, or even no greater than 2.5 microns.

Item 60. The composite or liner of any one of the preceding items, wherein the composite structure has an outer surface having a surface roughness of no greater than 10 Ra, no greater than 9 Ra, no greater than 8 Ra, no greater than 7 Ra, no greater than 6 Ra, no greater than 5 Ra, or even no greater than 4 Ra.

Item 61. The composite or liner of any one of the preceding items, wherein the composite structure has an outer surface having a surface roughness in a range of 0.05 Ra to 6 Ra, or even 0.1 Ra to 5 Ra.

Item 62. The composite or liner of any one of the preceding items, wherein the composite structure has a first outer surface and a second outer surface, opposite the first outer surface, and wherein the first outer surface a first surface roughness, and wherein the second outer surface has a second surface roughness, and wherein the first surface roughness is less than or equal to the second surface roughness.

Item 63. The composite or liner of any one of the preceding items, wherein the composite structure has a first outer major surface and a second outer major surface, opposite the first outer major surface, and wherein a ratio of the surface roughness of the second outer major surface to the surface roughness of the first outer major surface is at least at least 1, at least 2, at least 2.5, or even at least 3.

Item 64. The composite or liner of any one of the preceding items, wherein the composite structure has a first outer major surface and a second outer major surface, opposite the first outer major surface, and wherein a ratio of the surface roughness of the second outer major surface to the surface roughness of the first outer major surface is no greater than 50, no greater than 40, no greater than 30, no greater than 20, or even no greater than 10.

Item 65. The composite or liner of any one of the preceding items, wherein the composite or liner has a dielectric strength of at least 0.5 kV, at least 1 kV, or even at least 1.5 kV.

Item 66. The composite or liner of any one of the preceding items, wherein the composite or liner has a dielectric strength of no greater than 20 kV, no greater than 15 kV, or even no greater than 10 kV.

Item 67. The composite or liner of any one of the preceding items, wherein the composite or liner has a dielectric strength in a range of 0.5 kV to 15 kV or even 1.5 kV to 10 kV.

Item 68. The composite or liner of any one of the preceding items, wherein the composite or liner has a content of surface defects of no greater than 1000 outer surface defects per square meter, no greater than 900 outer surface defects per square meter, no greater than 800 outer surface defects per square meter, no greater than 700 outer surface defects per square meter, no greater than 600 outer surface defects per square meter, no greater than 500 outer surface defects per square meter, no greater than 400 outer surface defects per square meter, no greater than 300 outer surface defects per square meter, no greater than 200 outer surface defects per square meter, no greater than 100 outer surface defects per square meter, no greater than 75 outer surface defects per square meter, no greater than 50 outer surface defects per square meter, no greater than 40 outer surface defects per square meter, no greater than 30 outer surface defects per square meter, no greater than 20 outer surface defects per square meter, no greater than 15 outer surface defects per square meter, no greater than 10 outer surface defects per square meter, no greater than 8 outer surface defects per square meter, no greater than 7 outer surface defects per square meter, no greater than 6 outer surface defects per square meter, no greater than 5 outer surface defects per square meter, no greater than 4 outer surface defects per square meter, no greater than 3 outer surface defects per square meter, no greater than 2 outer surface defects per square meter, or even essentially free of outer surface defects per square meter, wherein surface defects consist of tower dust, dark particles, white spots, surfactant specs, sizing stains, burner dust, sheared coating material, such as PTFE, and weaving contaminations having a longest dimension of 0.1 mm as measured according to microscopic inspection under the Surface and Thickness Defect Test.

Item 69. The composite or liner of any one of the preceding items, wherein the composite or liner has a content of thickness defects of no greater than 1000 thickness defects per square meter, no greater than 900 thickness defects per square meter, no greater than 800 thickness defects per square meter, no greater than 700 thickness defects per square meter, no greater than 600 thickness defects per square meter, no greater than 500 thickness defects per square meter, no greater than 400 thickness defects per square meter, no greater than 300 outer thickness defects per square meter, no greater than 200 thickness defects per square meter, no greater than 100 thickness defects per square meter, no greater than 75 thickness defects per square meter, no greater than 50 thickness defects per square meter, no greater than 40 thickness defects per square meter, no greater than 30 thickness defects per square meter, no greater than 20 thickness defects per square meter, no greater than 15 thickness defects per square meter, no greater than 10 thickness defects per square meter, no greater than 8 thickness defects per square meter, no greater than 7 thickness defects per square meter, no greater than 6 thickness defects per square meter, no greater than 5 thickness defects per square meter, no greater than 4 thickness defects per square meter, no greater than 3 thickness defects per square meter, no greater than 2 thickness defects per square meter, or even essentially free of thickness defects per square meter, wherein thickness defects consist of clear bubbles or froth blisters which are microscopically perceptible thickness defects having a longest dimension of at least 0.1 mm as measured according to microscopic inspection under the Surface and Thickness Defect Test.

Item 70. The composite or liner of any one of the preceding items, wherein the composite or liner has a surface wicking and penetration of no greater than Level 2 or even no greater than Level 1 as measured according to the Fluorescent Dye Test.

Item 71. The composite or liner of any one of the preceding items, wherein the composite or liner has an edge wicking and penetration of no greater than 13 mm, no greater than 12 mm, no greater than 11 mm, no greater than 10 mm, no greater than 9 mm, no greater than 8 mm, no greater than 7 mm, or even no greater than 6 mm, no greater than 5 mm, no greater than 4 mm, no greater than 3 mm, or even no greater than 2 mm as measured according to the Red Dye Test.

Item 72. The composite or liner of any one of the preceding items, wherein the composite or liner has an edge wicking and penetration of at least 0.1 mm as measured according to the Red Dye Test.

Item 73. The composite or liner of any one of the preceding items, wherein the composite or liner has an edge wicking and penetration in a range of 0.01 to 10 mm, 0.1 mm to 9 mm, or even 0.1 mm to 8 mm as measured according to the Red Dye Test.

Item 74. The composite or liner of any one of the preceding items, wherein the composite or liner has a trapezoidal tear strength of at least 1 N, at least 3 N, at least 5 N, at least 7 N, at least 9 N, at least 11 N, at least 13 N, at least 15 N, at least 17 N, at least 19 N, at least 21 N, or even at least 23 N as measured according to ASTM D5587.

Item 75. The composite or liner of any one of the preceding items, wherein the composite or liner has a trapezoidal tear strength of no greater than 200 N, no greater than 150 N, no greater than 100 N, no greater than 75 N, no greater than 50 N, or even no greater than 25 N as measured according to ASTM D5587.

Item 76. The composite or liner of any one of the preceding items, wherein the composite or liner has a trapezoidal tear strength in a range of 5 N to 50 N, or even 11 N to 25 N as measured according to ASTM D5587.

Item 77. The composite or liner of any one of the preceding items, wherein the composite or liner has a tensile strength of at least 20 N/cm, at least 30 N/cm, at least 40 N/cm, at least 50 N/cm, at least 60 N/cm, at least 70 N/cm, at least 80 N/cm, at least 90 N/cm, at least 100 N/cm, at least 110 N/cm, at least 120 N/cm, at least 130 N/cm, at least 140 N/cm, at least 150 N/cm, at least 160 N/cm, at least 170 N/cm, at least 180 N/cm, at least 190 N/cm, or even at least 200 N/cm as measured according to ASTM D902-95.

Item 78. The composite or liner of any one of the preceding items, wherein the composite or liner has a tensile strength of no greater than 10000 N/cm, no greater than 5000 N/cm, no greater than 1000 N/cm, no greater than 500 N/cm, no greater than 300 N/cm, or even no greater than 250 N/cm as measured according to ASTM D902-95.

Item 79. The composite or liner of any one of the preceding items, wherein the composite or liner has a tensile strength in a range of 50 N/cm to 500 N/cm or even 100 N/cm to 250 N/cm as measured according to ASTM D902-95.

Item 80. The composite or liner of any one of the preceding items, wherein the composite or liner has one outer surface which can pass the Surface Tension Test using a reference ink having a surface tension of 38 mN/m, 36 mN/m, 34, mN/m, 32 mN/m, 30 mN/m, 28 mN/m, 26 mN/m, 24 mN/m, 22 mN/m, or even 20 mN/m.

Item 81. A bearing assembly, an actuator, an electromagnetic switch assembly, a solenoid valve assembly, or a transducer comprising the composite or liner of any one of the preceding items.

Item 82. The composite or liner of any one of the preceding items, wherein the composite or liner is self-lubricating.

Note that not all of the activities described above in the general description or the examples are required, that a portion of a specific activity may not be required, and that one or more further activities may be performed in addition to those described. Still further, the order in which activities are listed is not necessarily the order in which they are performed.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

The specification and illustrations of the embodiments described herein are intended to provide a general understanding of the structure of the various embodiments. The specification and illustrations are not intended to serve as an exhaustive and comprehensive description of all of the elements and features of apparatus and systems that use the structures or methods described herein. Separate embodiments may also be provided in combination in a single embodiment, and conversely, various features that are, for brevity, described in the context of a single embodiment, may also be provided separately or in any subcombination. Further, reference to values stated in ranges includes each and every value within that range. Many other embodiments may be apparent to skilled artisans only after reading this specification. Other embodiments may be used and derived from the disclosure, such that a structural substitution, logical substitution, or another change may be made without departing from the scope of the disclosure. Accordingly, the disclosure is to be regarded as illustrative rather than restrictive.

What is claimed is:

1. A composite comprising:
a. a first outer major surface and
b. a second outer major surface, opposite the first outer major surface,
c. wherein the first outer major surface is adapted to contact a movable surface, and
d. wherein the first outer major surface has a lower surface roughness than the second outer major surface; and
e. wherein the composite has a mean average thickness of less than 0.3 mm.

2. The composite of claim 1, wherein the composite structure consists essentially of the reinforcement material and the layer comprising a fluoropolymer.

3. The composite of claim 1, wherein the reinforcement layer comprises a woven fabric.

4. The composite of claim 1, wherein the reinforcement layer has a mean average thickness in a range of 0.015 mm to 0.3 mm.

5. The composite of claim 1, wherein the reinforcement layer has a weight per unit area in a range of 10 g/m² to 300 g/m².

6. The composite of claim 1, wherein the reinforcement layer comprises a woven fabric, and wherein the woven fabric comprises a plurality of warp yarns and fill yarns, and wherein the plurality of warp yarns have a mean average yarn width within a range of 50 microns to 500 microns.

7. The composite of claim 1, wherein the woven fabric reinforcement layer comprises a plurality of warp yarns and fill yarns, and wherein the plurality of warp yarns have a mean average width which is greater than a mean average height.

8. The composite of claim 1, wherein the layer comprising a fluoropolymer comprises a fluorinated polymer or fluorinated copolymer comprising polytetrafluoroethylene (PTFE), poly (tetrafluoroethylene-co-hexafluoropropylene (FEP), poly (tetrafluoroethylene-co-perfluoro (alkoxy vinyl ether)) (PFA), modified poly (ethylene-co-tetrafluoroethylene) (ETFE), poly (vinylidene fluoride) (PVDF), poly (chlorotrifluoroethylene) (PCTFE), MFA; or combination thereof.

9. The composite of claim 1, wherein the layer comprising a fluoropolymer has a mean average thickness in a range of 0.02 mm to 0.1 mm.

10. The composite of claim 1, wherein the layer comprising a fluoropolymer has a variability of thickness over warp yarn knuckles of no greater than +/−50 microns and a variability of thickness over the fill yarn knuckles of no greater than +/−50 microns.

11. The composite of claim 1, wherein the composite has a first outer major surface and a second outer major surface, opposite the first outer major surface, and wherein a ratio of the surface roughness of the second outer major surface to the surface roughness of the first outer major surface is at least 2 and no greater than 50.

12. The composite of claim 1, wherein the composite has a dielectric strength in a range of 1.5 kV to 10 kV.

13. The composite of claim 1, wherein the composite has a content of surface defects of no greater than 10 outer surface defects per square meter, wherein surface defects consist of tower dust, dark particles, white spots, surfactant specs, sizing stains, burner dust, sheared coating material, such as PTFE, and weaving contaminations having a longest dimension of 0.1 mm as measured according to microscopic inspection under the Surface and Thickness Defect Test.

14. The composite of claim 1, wherein the composite has a content of thickness defects of no greater than 10 thickness defects per square meter, wherein thickness defects consist of clear bubbles or froth blisters which are microscopically perceptible thickness defects having a longest dimension of at least 0.1 mm as measured according to microscopic inspection under the Surface and Thickness Defect Test.

15. The composite of claim 1, wherein the composite has a surface wicking and penetration of no greater than Level 2 as measured according to the Fluorescent Dye Test.

16. The composite of claim 1, wherein the composite has an edge wicking and penetration of no greater than 13 mm as measured according to the Red Dye Test.

17. The composite of claim 1, wherein the composite is a self-lubricating liner.

18. A bearing assembly, an actuator, an electromagnetic switch assembly, a solenoid valve assembly, or a transducer comprising the composite of claim 1.

19. A composite comprising:
a. a first outer major surface and
b. a second outer major surface, opposite the first outer major surface,
c. wherein the first outer major surface is adapted to contact a movable surface,
d. wherein the second outer major surface is adapted to hold against a stationary surface in an assembly; and
e. wherein the second outer major surface is adapted to pass the Surface Tension Test using a reference ink having a surface tension of 38 mN/m.

20. A composite comprising:
a. a reinforcement layer; and
b. a layer comprising a fluoropolymer disposed on the reinforcement layer;
c. wherein the composite structure has a mean average thickness of less than 0.3 mm, and
i. wherein the reinforcement layer has a mean average weight of no greater than 210 g/m²; and/or
ii. wherein the layer comprising a fluoropolymer has a mean average weight of no greater than 500 g/m².
